(19) United States
(12) Patent Application Publication
(10) Pub. No.: US 2026/0154044 A1
(43) Pub. Date: Jun. 4, 2026

(54) METHOD AND SYSTEM TO GENERATE RECOMMENDATIONS FOR EXECUTION OF COMPUTING APPLICATIONS

(71) Applicant: JPMorgan Chase Bank, N.A., New York, NY (US)

(72) Inventor: Swastik MOHANTY, Hyderabad (IN)

(73) Assignee: JPMorgan Chase Bank, N.A., New York, NY (US)

(21) Appl. No.: 19/024,494

(22) Filed: Jan. 16, 2025

(30) Foreign Application Priority Data
Dec. 4, 2024 (IN) 202411095559

(51) Int. Cl. G06F 8/30; G06F 8/41

(52) U.S. Cl. CPC G06F 8/30; G06F 8/443

(57) ABSTRACT

A method and system for generating recommendations for execution of computing applications are disclosed. The method includes analyzing a task code file received from a user to extract metadata. Next, the method includes parsing the metadata to retrieve a plurality of input parameters. Next, the method includes validating the task code file by running predefined rules against the input parameters. Next, the method includes estimating a plurality of metrics related to the task code file based on a result of the running of the predefined rules against the input parameters, wherein the estimation of the plurality of metrics is initiated upon a successful validation of the task code file. Next, the method includes generating a plurality of recommendations for the task code file based on the metrics. Next, the method includes executing the task code file based on the plurality of recommendations.

### CROSS-REFERENCE TO RELATED APPLICATIONS

This application claims priority benefit from Indian Application No. 202411095559, filed on Dec. 4, 2024 in the India Patent Office, which is hereby incorporated by reference in its entirety.

### FIELD OF THE DISCLOSURE

This technology generally relates to information processing systems, and more particularly relates to methods and systems to generate recommendations for execution of computing applications over a simulation framework.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In recent years, the demand for computational power to solve complex problems and process large-scale data sets has increased exponentially across various fields. Traditional computing architectures often struggle to meet the requirements of these demanding tasks due to limitations in processing power, memory, and scalability. As a result, there has been growing interest in developing applications capable of using parallel data processing (such as high-performance distributed applications or high computing applications) to improve computing performance and perform complex calculations.

Generally, high-performance distributed applications are impacted by various factors such as system software, hardware, and dataset factors (e.g., memory and Java virtual machine (JVM)), which makes capacity planning and tuning for clusters extremely difficult. Further, high-performance distributed applications face challenges during the software development lifecycle (SDLC) on big data platforms. The challenges may include, but are not limited to, the inability to predict job performance, the inability to detect job failures, no estimations for job cost, etc.

Some of the existing planning methods are mostly estimation-based and are highly dependent on experience. Also, existing planning methods mostly follow a trial-and-error approach during the SDLC of high-performance distributed applications. These approaches are inefficient and inaccurate, especially with increasing software stack complexity and hardware diversity. The existing planning methods for such applications have failed to predict job performance without running multiple iterations of the applications in an actual environment. Also, the existing planning methods are unable to identify job failures and long-running jobs at first instance, hence leading to post-fixes and corrections. The existing applications do not provide any recommendations for the identified issues, thereby leading to inefficient trial and error analysis. In the current scenario, developers require manual writing of test cases for complex data pipelines during the SDLC, hence making the testing phase cumbersome and time-consuming. Therefore, the existing methods and systems are expensive, require a lot of manual effort, and are also ineffective in resource utilization.

Hence, in view of these and other existing limitations, there arises an imperative need to provide an efficient solution to overcome the above-mentioned limitations and to provide a method and system that provide estimation of various real-time metrics to solve the issues faced during the software development life cycle on big data platforms.

### SUMMARY

The present disclosure, through one or more of its various aspects, embodiments, and/or specific features or sub-components, provides, inter alia, various systems, servers, devices, methods, media, programs, and platforms to generate recommendations for execution of computing applications over a simulation framework.

According to an aspect of the present disclosure, a method for generating recommendations for the execution of computing applications is disclosed. The method is implemented by at least one processor. The method includes receiving, by the at least one processor, at least one task code file from a user. Next, the method includes analyzing, by the at least one processor, the at least one task code file to extract metadata from the at least one task code file. Next, the method includes parsing, by the at least one processor, the metadata to retrieve a plurality of input parameters to identify an execution requirement for the at least one task code file. Next, the method includes validating, by the at least one processor, the at least one task code file by running predefined rules against the plurality of input parameters. Next, the method includes estimating, by the at least one processor, a plurality of metrics related to the at least one task code file based on a result of the running of the predefined rules against the plurality of input parameters, wherein the estimating of the plurality of metrics is initiated upon a successful validation of the at least one task code file. Next, the method includes generating, by the at least one processor, a plurality of recommendations for the at least one task code file based on the estimated plurality of metrics. Next, the method includes executing, by the at least one processor, the at least one task code file based on the plurality of recommendations.

In accordance with an exemplary embodiment, the method may further include receiving, by the at least one processor, a feedback from the user in response to the generating of the plurality of recommendations to manage rankings for the plurality of recommendations.

In accordance with an exemplary embodiment, the plurality of input parameters may include at least one from among task metrics, resource metrics, and infrastructure metrics.

In accordance with an exemplary embodiment, the predefined rules may include at least one from among business rules and validation rules.

In accordance with an exemplary embodiment, the plurality of recommendations may include at least one from among auto code generations, at least one auto generation of a test case, and computation and memory optimizations.

In accordance with an exemplary embodiment, the plurality of metrics may include at least one from among an estimation of an execution time, a cost incurrence, a running time, and an estimation of optimized and computation memory resources for the at least one task code file.

In accordance with an exemplary embodiment, the method may further include identifying, by the at least one processor, a plurality of existing recommendations for the at least one task code file in a repository. Next, the method may further include retrieving, by the at least one processor from the repository, at least one optimized existing recommendation for the at least one task code file. Next, the method may further include receiving, by the at least one processor from the user, a feedback that relates to the at least one optimized existing recommendation. Next, the method may further include executing, by the at least one processor, the at least one task file based on the at least one optimized existing recommendation.

According to another aspect of the present disclosure, a computing device configured to implement an execution of a method for generating recommendations for execution of computing applications is disclosed. The computing device includes a processor; a memory; and a communication interface coupled to each of the processor and the memory. The processor may be configured to receive at least one task code file from a user. Next, the processor may be configured to analyze the at least one task code file to extract metadata from the at least one task code file. Next, the processor may be configured to parse the metadata to retrieve a plurality of input parameters to identify an execution requirement for the at least one task code file. Next, the processor may be configured to validate the at least one task code file by running predefined rules against the plurality of input parameters. Next, the processor may be configured to estimate a plurality of metrics related to the at least one task code file based on a result of the running of the predefined rules against the plurality of input parameters, wherein the estimation of the plurality of metrics is initiated upon a successful validation of the at least one task code file. Next, the processor may be configured to generate a plurality of recommendations for the at least one task code file based on the estimated plurality of metrics. Next, the processor may be configured to execute the at least one task code file based on the plurality of recommendations.

In accordance with an exemplary embodiment, the processor may be further configured to receive a feedback from the user in response to the generation of the plurality of recommendations to manage rankings for the plurality of recommendations.

In accordance with an exemplary embodiment, the plurality of input parameters may include at least one from among task metrics, resource metrics, and infrastructure metrics.

In accordance with an exemplary embodiment, the predefined rules may include at least one from among business rules and validation rules.

In accordance with an exemplary embodiment, the plurality of recommendations may include at least one from among auto code generations, at least one auto generation of a test case, and computation and memory optimizations.

In accordance with an exemplary embodiment, the plurality of metrics may include at least one from among an estimation of an execution time, a cost incurrence, a running time, and an estimation of optimized and computation memory resources for the at least one task code file.

In accordance with an exemplary embodiment, the processor may be further configured to identify a plurality of existing recommendations for the at least one task code file in a repository. Next, the processor may be further configured to retrieve, from the repository, at least one optimized existing recommendation for the at least one task code file. Next, the processor may be further configured to receive a feedback from the user that relates to the at least one optimized existing recommendation. Next, the processor may be further configured to execute the at least one task file based on the at least one optimized existing recommendation.

According to yet another aspect of the present disclosure, a non-transitory computer-readable storage medium storing instructions for generating recommendations for execution of computing applications is disclosed. The instructions include executable code which, when executed by a processor, may cause the processor to receive at least one task code file from a user; analyze the at least one task code file to extract metadata from the at least one task code file; parse the metadata to retrieve a plurality of input parameters to identify an execution requirement for the at least one task code file; validate the at least one task code file by running predefined rules against the plurality of input parameters; estimate a plurality of metrics related to the at least one task code file based on a result of the running of the predefined rules against the plurality of input parameters, wherein the estimation of the plurality of metrics is initiated upon a successful validation of the at least one task code file; generate a plurality of recommendations for the at least one task code file based on the estimated plurality of metrics; and execute the at least one task code file based on the plurality of recommendations.

In accordance with an exemplary embodiment, the executable code when executed may further cause the processor to receive a feedback from the user in response to the generation of the plurality of recommendations to manage rankings for the plurality of recommendations.

In accordance with an exemplary embodiment, the plurality of input parameters may include at least one from among task metrics, resource metrics, and infrastructure metrics.

In accordance with an exemplary embodiment, the predefined rules may include at least one from among business rules and validation rules.

In accordance with an exemplary embodiment, the plurality of recommendations may include at least one from among auto code generations, at least one auto generation of a test case, and computation and memory optimizations.

In accordance with an exemplary embodiment, the plurality of metrics may include at least one from among an estimation of an execution time, a cost incurrence, a running time, and an estimation of optimized and computation memory resources for the at least one task code file.

In accordance with an exemplary embodiment, the executable code when executed may further cause the processor to identify a plurality of existing recommendations for the at least one task code file in a repository. Next, the executable code when executed may further cause the processor to retrieve, from the repository, at least one optimized existing recommendation for the at least one task code file. Next, the executable code when executed may further cause the processor to receive a feedback from the user that relates to the at least one optimized existing recommendation. Next, the executable code when executed may further cause the processor to execute the at least one task file based on the at least one optimized existing recommendation.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system that is usable in connection with executing a method for generating recommendations for execution of computing applications, in accordance with an exemplary embodiment of the present disclosure.

FIG. 2 illustrates an exemplary diagram of a network environment that is usable in connection with executing a method for generating recommendations for execution of computing applications, in accordance with an exemplary embodiment of the present disclosure.

FIG. 3 illustrates an exemplary system that is usable in connection with executing a method for generating recommendations for execution of computing applications, in accordance with an exemplary embodiment of the present disclosure.

FIG. 4 illustrates an exemplary method flow diagram of a method for generating recommendations for execution of computing applications, in accordance with an exemplary embodiment of the present disclosure.

FIG. 5 illustrates a process flow diagram of a method for generating recommendations for execution of computing applications, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system for generating recommendations for execution of computing applications. More particularly, various high computing applications often face problems during a software development lifecycle (SDLC) on big data platforms such as the inability to predict job performance or identify job failures, and/or a lack of recommendations for the identified issues, leading to inefficient trial and error analysis for the high computing applications. The present disclosure provides a recommendation system that may estimate real-time metrics such as cost, execution time, and job failures to provide recommendations (for example, auto-generated codes) for such high computing applications. In the present disclosure, at first, the system receives at least one task code file from a user. Further, the system analyzes the at least one task code file to extract metadata from the at least one task code file. The system further parses the metadata to retrieve a plurality of input parameters to identify an execution requirement for the at least one task code file. Further, the system validates the at least one task code file by running predefined rules against the plurality of input parameters. Furthermore, the system estimates a plurality of metrics related to the at least one task code file based on a result of the running of the predefined rules against the plurality of input parameters, wherein the estimation of the plurality of metrics is initiated upon a successful validation of the at least one task code file. Further, the system generates a plurality of recommendations for the at least one task code file based on the estimated plurality of metrics. The system further executes the at least one task code file based on the plurality of recommendations. In this manner, the system uses the recommendations for the execution of computing applications over a simulation framework.

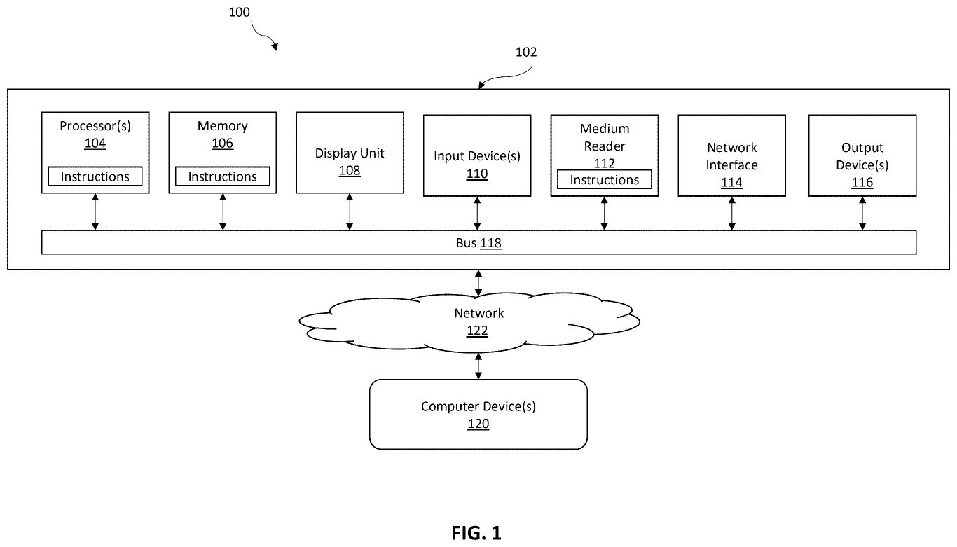

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article about manufacturing and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computer device 120 is shown in FIG. 1 as a personal computer. However, those skilled in the art will appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for generating recommendations for execution of computing applications.

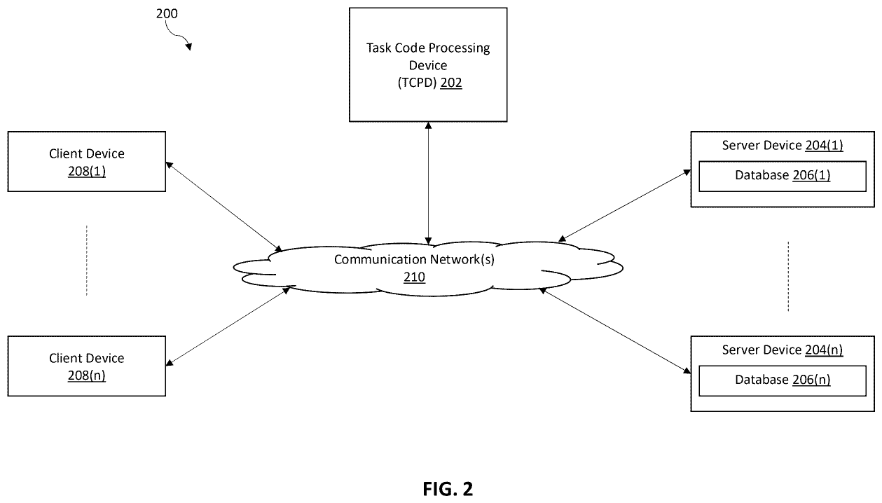

Referring to FIG. 2, a schematic of an exemplary network environment 200 that is usable in connection with executing a method for generating recommendations for execution of computing applications is illustrated. In an exemplary embodiment, the method is executable on any networked computer platform, such as, for example, a personal computer (PC).

The method for generating recommendations for execution of computing applications may be executed by a task code processing device (TCPD) 202. The TCPD 202 may be the same or similar to the computer system 102 as described with respect to FIG. 1. The TCPD 202 may store one or more applications that may include executable instructions that, when executed by the TCPD 202, cause the TCPD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the TCPD 202 itself, may be located in the virtual server(s) running in a cloud-based computing environment rather than being tied to one or more specific physical network computing devices. Also, the application(s) may be running in one or more virtual machines (VMs) executing on the TCPD 202. Additionally, in one or more embodiments of this technology, virtual machine(s) running on the TCPD 202 may be managed or supervised by a hypervisor.

In the network environment 200 of FIG. 2, the TCPD 202 is coupled to a plurality of server devices 204(1)-204(n) that hosts a plurality of databases 206(1)-206(n), and also to a plurality of client devices 208(1)-208(n) via communication network(s) 210. A communication interface of the TCPD 202, such as the network interface 114 of the computer system 102 of FIG. 1, operatively couples and communicates between the TCPD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TCPD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and TCPDs that efficiently implement the method for generating recommendations for execution of computing applications.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The TCPD 202 may be a standalone device or integrated with one or more other devices or apparatuses, such as one or more of the server devices 204(1)-204(n), for example. In one particular example, the TCPD 202 may include or be hosted by one of the server devices 204(1)-204(n), and other arrangements are also possible. Moreover, one or more of the devices of the TCPD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the TCPD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to a plurality of recommendations and a plurality of metrics related to at least one task code file.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the TCPD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the TCPD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the TCPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the TCPD 202, the server devices 204(1)-204(n), or the client devices 208(1)-208(n), for example, may be configured to operate as virtual instances on the same physical machine. In other words, one or more of the TCPD 202, the server devices 204(1)-204(n), or the client devices 208(1)-208(n) may operate on the same physical device rather than as separate devices communicating through communication network(s) 210. Additionally, there may be more or fewer TCPDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

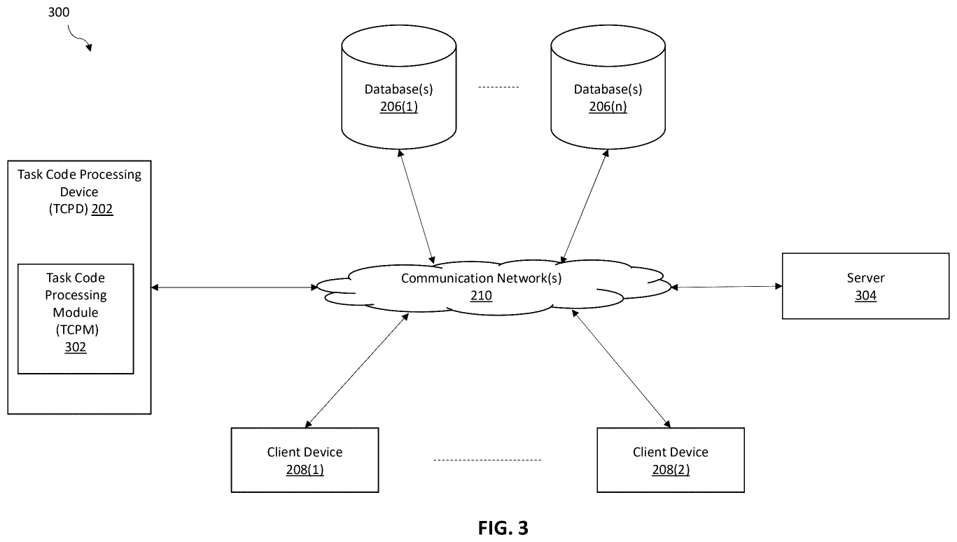

FIG. 3 illustrates an exemplary system that is usable in connection with executing a method for generating recommendations for execution of computing applications, in accordance with an exemplary embodiment. As illustrated in FIG. 3, according to exemplary embodiments, the system 300 may comprise a task code processing device (TCPD) 202 including a task code processing module (TCPM) 302 that may be connected to a server device 204(1) and at least one repository from the repositories 206(1) . . . 206(n) via a communication network 210, but the disclosure is not limited thereto.

The TCPD 202 is described and shown in FIG. 3 as including the TCPM 302, although it may include other rules, policies, modules, databases, or applications, for example. As will be described below, the TCPM 302 is configured to carry out a method for generating recommendations for the execution of computing applications.

An exemplary system 300 for enabling a mechanism for generating recommendations for execution of computing applications by utilizing the network environment of FIG. 2 is shown as being executed in FIG. 3. Specifically, a first client device 208(1) and a second client device 208(2) are illustrated as being in communication with the TCPD 202. In this regard, the first client device 208(1) and the second client device 208(2) may be “clients” of the TCPD 202 and are described herein as such. Nevertheless, it is to be known and understood that the first client device 208(1) and/or the second client device 208(2) need not necessarily be “clients” of the TCPD 202, or any entity described in association therewith herein. Any additional or alternative relationship may exist between either or both of the first client device 208(1) and the second client device 208(2) and the TCPD 202, or no relationship may exist.

Further, the TCPD 202 is illustrated as being able to access one or more repositories 206(1) . . . 206(n). The TCPM 302 may be configured to access these repositories/databases to provide a method for generating recommendations for execution of computing applications.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the TCPD 202 via broadband or cellular communication. These embodiments are merely exemplary and are not limiting or exhaustive.

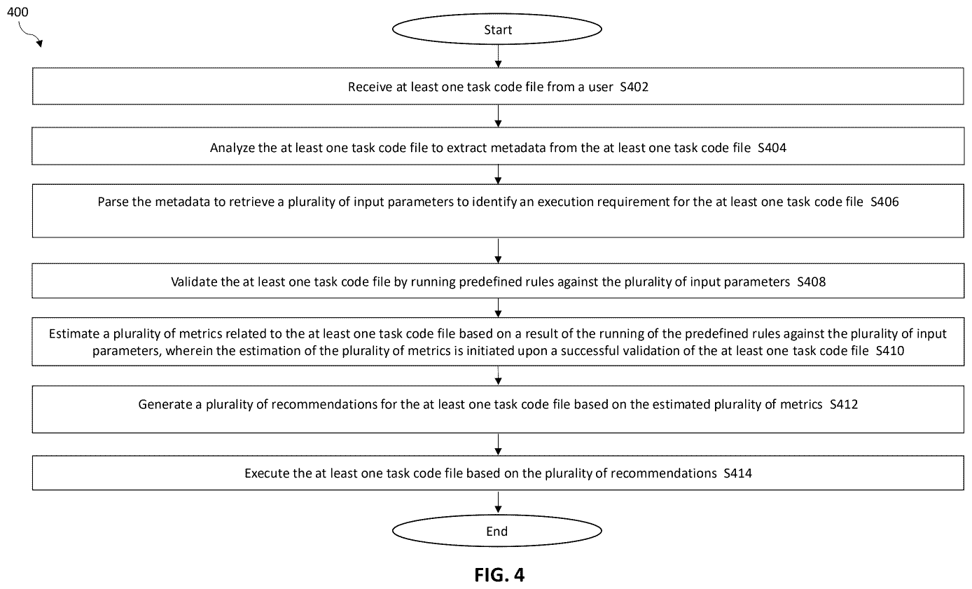

Referring to FIG. 4, an exemplary method 400 is shown for generating recommendations for execution of computing applications, in accordance with an exemplary embodiment. In particular, the exemplary method 400 is shown for generating recommendations for execution of computing applications.

As shown in FIG. 4, method 400 begins following a need to generate recommendations for execution of high computing applications to fix issues faced by the high-computing applications during a software development lifecycle (SDLC) on big data platforms. The method 400 is implemented by at least one processor 104.

At step S402, the method 400 includes receiving, by the at least one processor 104, at least one task code file from a user.

The term “task code file” herein may correspond to a file that contains the code or script necessary to execute a specific computational task or job. The task code file may include the instructions required to perform complex computations, data analyses, simulations, or other operations on the big data platforms.

The term “application” herein may correspond to a software program or tool that is designed to perform specific tasks or functions for the user.

For example, a user may provide the task code file (e.g., a distributed application job or distributed high computing job) via an application or a website.

In one exemplary implementation, the method includes fetching, by the at least one processor 104, the at least one task code file from at least one external source. The at least one external source may be selected from but not limited to, a server, a cloud server, at least one database, network-attached storage solid state drive (SSD), or other memory storage means. The database may be connected with the at least one processor 104 via a network. The network may be an Internet-based network.

The at least one external source may be connected with an application or website which a user might be using to raise a request for processing the at least one task code file.

In one exemplary implementation, the at least one task code file may be fetched using secure data communication protocols to ensure the integrity and confidentiality of the at least one task code file.

It will be appreciated by the person skilled in the art that the aim here is to create a system that provides recommendations and estimate real-time metrics for the at least one task code file.

At step S404, the method includes analyzing, by the at least one processor 104, the at least one task code file to extract metadata from the at least one task code file.

The term “metadata” herein may correspond to information that describes any one or more of computational resources, job specifications, input/output data, and performance metrics for efficient management, scheduling, and optimization of compute-intensive tasks on large-scale computing infrastructures such as big data platforms.

In an implementation, the metadata may include a series of steps explaining the execution path or event log for the at least one task code file. In an implementation, the metadata may be stored in a directed acyclic graph (DAG) form.

The term “directed acyclic graph” herein may correspond to a structured data representation that visually depicts the sequence, dependencies, and interactions among individual tasks or components within a software system or computational workflow.

At step S406, the method includes parsing, by the at least one processor 104, the metadata to retrieve a plurality of input parameters to identify an execution requirement for the at least one task code file.

The term “parameters” herein may correspond to the diverse range of data inputs, configuration settings, and environmental variables that an application or a task code file requires across different stages of its lifecycle.

The plurality of input parameters may include but are not limited to any one or more of task metrics, resource metrics, and infrastructure metrics. The task metrics may include, but are not limited to, any one or more of an execution time, an error rate, a latency, a data transfer rate, and a task completion status. The resource metrics may include but are not limited to any one or more of a central processing unit (CPU) utilization, a memory usage, input and output operations on disk storage, a network bandwidth, a type of data source, a total data size, a total number of partitions, a number of datasets in use, and a storage capacity. The infrastructure metrics may include any one or more of a server uptime, a service availability, a resource utilization, a fault tolerance, and an infrastructure cost.

At step S408, the method includes validating, by the at least one processor 104, the at least one task code file by running predefined rules against the plurality of input parameters. The predefined rules are selected from, but not limited to, any one or more of business rules and validation rules. The business rules refer to a set of input and output parameters that are defined on which artificial intelligence (AI) process needs to be executed. The validation rules verify whether or not the given input is correct and/or whether or not the output generated is as per the requirement from the user. For example, the system checks if a recommendation is already provided, if yes then the system may skip the rest of the processing and send the recommendation from a response layer for the at least one task code file.

In an exemplary implementation, the at least one processor 104 applies business rules and validation rules to the plurality of parameters such as task metrics, resource metrics, and infrastructure metrics to validate the at least one task code file.

Once the at least one task code file is validated, the at least one processor 104 identifies a plurality of existing recommendations for the at least one task code file in a repository (e.g., a cache repository). If the plurality of existing recommendations is available in the repository, then the method may further include retrieving, by the at least one processor 104 from the repository, at least one optimized existing recommendation for the at least one task code file. Furthermore, the method may further include receiving, by the at least one processor 104, a feedback from the user that relates to the at least one optimized existing recommendation. Finally, the method may further include executing, by the at least one processor 104, the at least one task file based on the at least one optimized existing recommendation. The feedback may be further stored in a database (also referred to as “ranking system repository”) and used for providing a ranking for recommendations to provide the best possible recommendations.

The method may further transmitting, by the at least one processor 104, the at least one task code file to the user in case of failure of validation of the at least one task code file.

In an exemplary implementation, the method may further include generating, by the at least one processor 104, a detailed failure message in the event of unsuccessful validation of the at least one task code file. In an implementation, the at least one processor 104 may transmit a notification over a user interface (UI) of a platform to notify the user. In an implementation, the notification may be customized to be delivered via various channels, such as email, short message service (SMS), or even as a push notification from an application, depending on the system's capabilities.

At step S410, the method includes estimating, by the at least one processor 104, a plurality of metrics related to the at least one task code file based on a result of the running of the predefined rules against the plurality of input parameters. The estimation of the plurality of metrics may be initiated upon a successful validation of the at least one task code file.

For example, if no recommendation is identified in the repository for the at least one task code file, then the at least one processor 104 may further process the at least one task code file and then generate estimations for the plurality of metrics.

The plurality of metrics may include but is not limited to any one or more of an estimation of an execution time, a cost incurrence, a running time, and an estimation of optimized and computation memory resources for the at least one task code file. The plurality of metrics helps the user to understand real-time progress of the at least one task code file and it saves the cost of development and reduces manual efforts that are required during the SDLC in the existing practices such as trial and error.

At step S412, the method includes generating, by the at least one processor 104, a plurality of recommendations for the at least one task code file based on the estimated plurality of metrics.

The plurality of recommendations may include any one or more of auto code generations, auto generation of one or more test cases, and computation and memory optimizations. Based on the data size, total number of partitions, total number of datasets and complexity of the transformation and aggregation logic, the at least one processor 104 may generate the most optimized spark code (e.g., auto codes) that is provided to the user to use and implement. With regard to test cases, there can be different data scenarios based on which different test cases would need to be written, so the current system may generate auto test cases based on the data complexity and output data requirements that will be ideal for a developer to test and validate without manual touch points.

In an implementation, the method may further include receiving, by the at least one processor 104, a feedback from the user in response to the plurality of recommendations to manage rankings for the plurality of recommendations. The feedback may include asking the user to provide inputs on the recommendations (for example, good or bad for the generated recommendations).

Further, the method may further include storing, by the at least one processor 104, the feedback received from the user in response to the plurality of recommendations in the database (also referred to as “ranking system repository”).

For example, the user feedback may be further used to provide better recommendations for simulation of the at least one task code file and also used to revise rankings for the plurality of recommendations. This way the present disclosure provides the best possible recommendations for the at least one task code file.

At step S414, the method includes executing, by the at least one processor 104, the at least one task code file based on the plurality of recommendations.

For example, test cases may be executed based on the plurality of recommendations to successfully run and complete the task code file in lower environments.

In one exemplary implementation, the method may further include generating, by the at least one processor 104, reports and alerts to the user in case of successful execution of the at least one task code file.

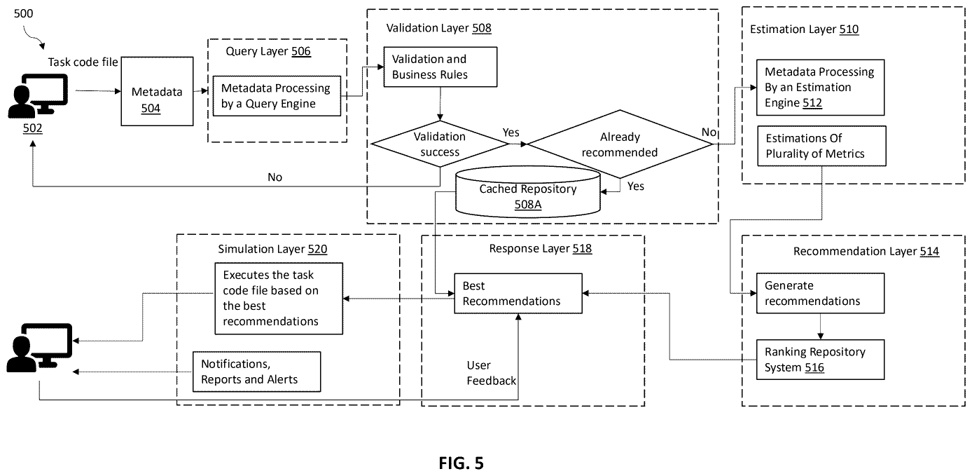

FIG. 5 illustrates a process flow diagram that represents a method for generating recommendations for execution of computing applications, in accordance with an exemplary embodiment. As illustrated in FIG. 5, the process flow 500 begins with receiving at least one task code file from a user via a user device 502. The user device 502 may be employed with a user platform, and by using the user platform, the user may be able to raise a request related to the at least one task code file.

Further, a metadata 504 for the task code file is further received by a processor 104 of the disclosed system. The metadata 504 further gets transmitted to a query layer 506. The query layer 506 may be employed with a query engine (or the query layer 506) and a metadata and log parser. The query engine further parses the metadata 504 to retrieve a plurality of input parameters. Further, a validation layer 508 is configured to validate the at least one task code file by running predefined business rules and validation rules against the plurality of input parameters received from the query layer 506.

If the at least one task code file is invalid, then the processor 104 transmits a failure notification to the user platform to notify the user. If the at least one task code file is valid, then the processor 104 checks for the presence of any existing recommendation for the at least one task code file in a cached repository 508A (also referred to as a repository 508A). If the presence of any existing recommendation is detected in the repository 508A for the at least one task code file, then the processor 104 further transmits a user feedback request to a user to receive the user feedback for the existing recommendation. Further, the at least one task code file gets executed directly in a simulation layer 520 to successfully run the at least one task code file based on the existing recommendation.

If the recommendation is unavailable for the at least one task code in the cached repository 508A then the processor 104 further processes the at least one task code file. Furthermore, an estimation layer 510 is employed with an estimation engine 512 configured to process the metadata (for example, metadata processing) and estimate a plurality of metrics by processing (for example, query output processing) the plurality of input parameters. The estimation of the plurality of metrics is initiated upon a successful validation of the at least one task code file.

Further, the plurality of metrics is transmitted to a recommendation layer 514. The recommendation layer 514 is configured to generate recommendations for the at least one task code file based on the estimated plurality of metrics. The recommendations may be stored in a ranking repository system 516. The ranking repository system 516 may receive feedback from the user to manage ranking of the recommendations in order to provide the best recommendations to a response layer 518. The response layer 518 further transmits the best recommendations for the at least one task code file to the simulation layer 520. In the simulation layer 520, the at least one task code file gets executed based on the recommendations provided from the response layer 518. The simulation layer 520 may transmit notification(s) to the user platform in case of successful execution of the at least one task code file. The simulation layer 520 may generate reports and alerts related to the at least one task code file in a predefined format and transmit it to the user platform for further reference. In an exemplary implementation, the reports may include cost optimization reports, performance optimization reports, and code recommendation reports. The cost optimization reports may include the most cost-effective infrastructure and techniques as part of the recommendation for the at least one task code file. The performance optimization reports consist of computation and memory recommendations, best practices to be followed to achieve optimal performance results, and auto generated test cases suitable for performance testing of the data pipelines. Code recommendation reports may include spark codes for the at least one task code file.

It will be appreciated by the person skilled in the art that the disclosed method offers a full-circle, adaptable, and intelligent solution for implementing a method to generate recommendations for execution of computing applications over a simulation framework.

The present disclosure provides numerous advantages as given below. The present disclosure provides a simulation framework for testing high computing applications. The present disclosure successfully reduces the cost of the development of high computing applications. The present disclosure enables users to detect a plurality of real-time metrics such as execution time, cost estimation, and long-running tasks related to high computing applications or jobs. The present disclosure provides recommendations for the high computing applications without actually running them on actual systems or a live environment. Therefore, the present discourse allows efficient utilization of resources which leads to cost savings during the testing phase and infrastructure.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for generating recommendations for execution of computing applications is disclosed. The instructions include executable code which, when executed by a processor 104, may cause the processor 104 to receive, via a communication interface, at least one task code file from a user; analyze the at least one task code file to extract metadata from the at least one task code file; parse the metadata to retrieve a plurality of input parameters to identify an execution requirement for the at least one task code file; validate the at least one task code file by running predefined rules against the plurality of input parameters; estimate a plurality of metrics related to the at least one task code file based on a result of the running of the predefined rules against the plurality of input parameters, wherein the estimation of the plurality of metrics is initiated upon a successful validation of the at least one task code file; generate a plurality of recommendations for the at least one task code file based on the estimated plurality of metrics; and execute the at least one task code file based on the plurality of recommendations.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for generating recommendations for execution of computing applications, the method being implemented by at least one processor, the method comprising:
receiving, by the at least one processor, at least one task code file from a user;
analyzing, by the at least one processor, the at least one task code file to extract metadata from the at least one task code file;
parsing, by the at least one processor, the metadata to retrieve a plurality of input parameters to identify an execution requirement for the at least one task code file;
validating, by the at least one processor, the at least one task code file by running predefined rules against the plurality of input parameters;
estimating, by the at least one processor, a plurality of metrics related to the at least one task code file based on a result of the running of the predefined rules against the plurality of input parameters, wherein the estimating of the plurality of metrics is initiated upon a successful validation of the at least one task code file;
generating, by the at least one processor, a plurality of recommendations for the at least one task code file based on the estimated plurality of metrics; and
executing, by the at least one processor, the at least one task code file based on the plurality of recommendations.

2. The method as claimed in claim 1, further comprising:
receiving, by the at least one processor, a feedback from the user in response to the generating of the plurality of recommendations to manage rankings for the plurality of recommendations.

3. The method as claimed in claim 1, wherein the plurality of input parameters includes at least one from among task metrics, resource metrics, and infrastructure metrics.

4. The method as claimed in claim 1, wherein the predefined rules include at least one from among business rules and validation rules.

5. The method as claimed in claim 1, wherein the plurality of recommendations includes at least one from among auto code generations, at least one auto generation of a test case, and computation and memory optimizations.

6. The method as claimed in claim 1, wherein the plurality of metrics includes at least one from among an estimation of an execution time, a cost incurrence, a running time, and an estimation of optimized and computation memory resources for the at least one task code file.

7. The method as claimed in claim 1, further comprising:
identifying, by the at least one processor, a plurality of existing recommendations for the at least one task code file in a repository;
retrieving, by the at least one processor, from the repository, at least one optimized existing recommendation for the at least one task code file;
receiving, by the at least one processor from the user, a feedback that relates to the at least one optimized existing recommendation; and
executing, by the at least one processor, the at least one task file based on the at least one optimized existing recommendation.

8. A computing device configured to generate recommendations for execution of computing applications, the computing device comprising:
a processor;
a memory; and
a communication interface coupled to each of the processor and the memory,
wherein the processor is configured to:
receive at least one task code file from a user;
analyze the at least one task code file to extract metadata from the at least one task code file;
parse the metadata to retrieve a plurality of input parameters to identify an execution requirement for the at least one task code file;
validate the at least one task code file by running predefined rules against the plurality of input parameters;
estimate a plurality of metrics related to the at least one task code file based on a result of the running of the predefined rules against the plurality of input parameters, wherein the estimation of the plurality of metrics is initiated upon a successful validation of the at least one task code file;
generate a plurality of recommendations for the at least one task code file based on the estimated plurality of metrics; and
execute the at least one task code file based on the plurality of recommendations.

9. The computing device as claimed in claim 8, wherein the processor is further configured to receive a feedback from the user in response to the generation of the plurality of recommendations to manage rankings for the plurality of recommendations.

10. The computing device as claimed in claim 8, wherein the plurality of input parameters includes at least one from among task metrics, resource metrics, and infrastructure metrics.

11. The computing device as claimed in claim 8, wherein the predefined rules include at least one from among business rules and validation rules.

12. The computing device as claimed in claim 8, wherein the plurality of recommendations includes at least one from among auto code generations, at least one auto generation of a test case, and computation and memory optimizations.

13. The computing device as claimed in claim 8, wherein the plurality of metrics includes at least one from among an estimation of an execution time, a cost incurrence, a running time, and an estimation of optimized and computation memory resources for the at least one task code file.

14. The computing device as claimed in claim 8, wherein the processor is further configured to:
identify a plurality of existing recommendations for the at least one task code file in a repository;
retrieve, from the repository, at least one optimized existing recommendation for the at least one task code file;
receive a feedback from the user that relates to the at least one optimized existing recommendation; and
execute the at least one task file based on the at least one optimized existing recommendation.

15. A non-transitory computer readable storage medium storing instructions for generating recommendations for execution of computing applications, the storage medium comprising executable code which, when executed by a processor, causes the processor to:
receive at least one task code file from a user;
analyze the at least one task code file to extract metadata from the at least one task code file;
parse the metadata to retrieve a plurality of input parameters to identify an execution requirement for the at least one task code file;
validate the at least one task code file by running predefined rules against the plurality of input parameters;
estimate a plurality of metrics related to the at least one task code file based on a result of the running of the predefined rules against the plurality of input parameters, wherein the estimation of the plurality of metrics is initiated upon a successful validation of the at least one task code file;
generate a plurality of recommendations for the at least one task code file based on the estimated plurality of metrics; and
execute the at least one task code file based on the plurality of recommendations.

16. The storage medium as claimed in claim 15, wherein when executed by the processor, the executable code further causes the processor to receive a feedback from the user in response to the generation of the plurality of recommendations to manage rankings for the plurality of recommendations.

17. The storage medium as claimed in claim 15, wherein the plurality of input parameters includes at least one from among task metrics, resource metrics, and infrastructure metrics.

18. The storage medium as claimed in claim 15, wherein the predefined rules include at least one from among business rules and validation rules.

19. The storage medium as claimed in claim 15, wherein the plurality of recommendations includes at least one from among auto code generations, at least one auto generation of a test case, and computation and memory optimizations.

20. The storage medium as claimed in claim 15, wherein the plurality of metrics includes at least one from among an estimation of an execution time, a cost incurrence, a running time, and an estimation of optimized and computation memory resources for the at least one task code file.
